(19) United States
(12) Patent Application Publication
(10) Pub. No.: US 2003/0182844 A1
(43) Pub. Date: Oct. 2, 2003

(54) Knotless fishhook or the like

(76) Inventor: Brendan Berthold, Keewatin, MN (US)

Correspondence Address: BRENDAN BERTHOLD, P.O. Box 671, Keewatin, MN, 55753-0671, US

(21) Appl. No.: 10/396,208

(22) Filed: Mar. 25, 2003

Related U.S. Application Data
(60) Provisional application No. 60/367,919, filed on Mar. 27, 2002.

(51) Int. Cl. A01K 91/04

(52) U.S. Cl. 43/44.83

(57) ABSTRACT

An article of terminal tackle including a shank portion has a line retaining appendage at one end so attached to the shank as to provide a open ended angle. The line gripping appendage has a nub at each of its ends. A tubular body surrounds the shank that is capable of encapsulating the shank, the line gripping appendage and line wrapped around the shank. The nubs on the line gripping appendage are capable of holding the tubular body in place until the line gripping appendage is purposely pressed into the shank at its open ended area.

### BACKGROUND

1. Field of Invention

This invention relates generally to terminal tackle. More particularly the present invention is in the form of a fishhook that can be easily and rapidly attached and detached to fishing line or the like.

2. Description of Prior Art

The tying of modem fishing line to terminal tackle presents many problems. Most of the terminal tackle employed today requires the fisherman to thread his line through an eyelet and tie an appropriate knot. The use of such lines, because of their fine diameter makes the threading of eyelets, which are often very small, difficult. After threading the eyelet the fisherman then needs to tie a secure knot. This method is difficult and time consuming even under ideal conditions. Many fishermen will find themselves in adverse conditions such as poor weather, in a rocking boat, low light conditions and with cold and wet hands. Also, some fishermen have an inability to readily see fine objects like the end of the fishing line and eyelet. Still others, lack the skill or are inexperienced in knot tying or have a physical impairment that precludes them from using eyelet based tackle.

One development in the field of improved tackle tying is shown in U.S. Pat. No. 1,156,152 issued on Oct. 12, 1915 to C.A. Krenrick. This patent teaches a method of attaching line to a hook by knotting the end of the line, laying the line in parallel against a corrugated hook shank and then clamping a band around both line and hook shank. This device has these disadvantages: the making of a knot, the need for an appropriate tool to clamp the band, extra new bands for when the user changes hooks as the bands will loose their ability to properly form after one usage. Also the fact that this device is in multiple pieces increases the odds that one piece can be misplaced, rendering the device unusable.

U.S. Pat. No. 3,138,840 issued on Jun. 30, 1964 to A.E. Rich discloses a device in which the end of the fishing line is passed through an enlarged helical looped eyelet. This end portion is held against the hook shank and the fishing line is wrapped twice around both the end portion of the fishing line and the hook shank. After wrapping, the fishing line is then brought between the loops of the eyelet and pulled tightly. This device has a major disadvantage, being, that a fighting fish may easily cause the fishing line pressed between the loops to disengage and cause the fishing line to unravel, loosing both fish and hook.

U.S. Pat. No. 4,879,835 issued Nov. 14, 1989 to Sprayberry shows a device in which an object like a lead sinker permanently replaces the eyelet of a fishhook. There is a slit in the sinker through which fishing line is passed then wrapped around the hook shank, and passed again through the slit. The line is then pulled tight, and the slit is pressed together. Again, a fighting fish may force the fishing line back out of the slit and unwrap it from the hook. There is no positive locking means to hold the slit together.

U.S. Pat. No. 5,279,067 issued Jan. 18, 1994 to Tollison describes a method of attaching fishing line to a hook having an open-ended slot whereby a properly wrapped line entwines upon itself in the slot when pulled. This device and its method of use gives rise to several problems. One problem is the cumbersome method of wrapping the line around the shank. Another problem is that once tied, the hook would tend to hang in a horizontal or near horizontal position, this makes the baited hook hang in an unnatural and undesirable position underwater. Yet another problem with this design is that it may be easily untied by a fighting fish as there is no positive means for preventing the line from backing out of the slot and unwrapping.

U.S. Pat. No. 5,524,385 issued Jun. 11, 1996 to Longo shows a fishhook with a tube attached to the hooks shank. The user is to thread the fishing line through this tube and knot it to the shank. The user must still thread and knot the fishing line with this device.

U.S. Pat. No. 5,689,911 issued Nov. 25, 1997 to Lin shows a variation of U.S. Pat. No. 5,279,067. The preferred embodiment in this variation only partially solves the problem of the line backing out by providing surface to surface contact after the line receiving opening. However, this is not a positive lock. The contacted surfaces are only held together with the spring tension provided by the bend used to form the slotted portion. A fighting fish may be able to force the line back out of the slot in its attempt to escape. Again, as with Tollison's, the fishing line is not kept in linear conjunction with the hook shank, causing an unnatural and undesirable hook position underwater.

U.S. Pat. No. 5,881,491 issued Mar. 16, 1999 to Kira describes a fishhook that has a flattened end with a slot leading to a hole. The slot is equal to or slightly smaller in width to the diameter of the fishing line being used and the hole is twice the diameter of the fishing line being used. The user slips the end portion of the fishing line through the slot into the hole, then wraps the line around the shank and end portion of line several times and again presses the line through the slot into the hole. Once again there is no means of positively locking the line in the slot or hole. Also the width of the slot and diameter of the hole needs to be size specific to the diameter of the fishing line. This results in the need for the fisherman to carry many different sizes of hooks to match different fishing line sizes.

### SUMMARY OF THE INVENTION

The present invention is a fishing hook that comprises a shank portion, a tubular body surrounding said shank, a hook at one end, and a line gripping appendage attached at the opposite and opposed end from the hook. The line gripping appendage has a nub at each of its ends.

### OBJECTS AND ADVANTAGES

Accordingly, several objects and advantages of my invention are:

(a) the need to thread an eyelet has been eliminated

(b) the need to tie a knot has been eliminated

(c) ease and simplicity of attaching line is greatly enhanced

(d) speed of attaching line is greatly enhanced

(e) no tools are required for usage

(f) the invention is reusable

(g) a positive locking means is provided so the line cannot back out

(h) a means is provided so hook and line are held in linear conjunction

(i) most all line sizes can be used as the invention is a “one size fits most” device

(j) all parts are interlocked so pieces cannot become lost

Further objects and advantages are to provide a fishhook that can also help in the attraction of fish to bite, by having the various parts colored, patterned, luminescent, textured or having some extremities attached to them. The selection in materials of various parts can make the invention either positively or negatively buoyant. Still further objects and advantages will become apparent from a consideration of the ensuing description and drawings.

### DRAWING FIGURES

FIG. 1 shows a perspective view of the present invention in its preferred embodiment

FIG. 2 shows a perspective view of the present invention in a stage of line attachment

FIG. 3 shows a perspective view of the present invention in another stage of line attachment

FIG. 4 shows a perspective view of the present invention with the line fully attached

FIG. 5 shows a perspective view of the present invention using an alternate construction method

### REFERENCE NUMERALS IN DRAWINGS

| | |
|---|---|
| 20 barb | 22 bend |
| 24 shank | 30 focking tube |
| 40 locking arm | 42 top nub |
| 44 bottom nub | 46 locking arm tip |
| 50 open ended angle | 70 fishing line |
| 80 join | |

### DESCRIPTION OF INVENTION

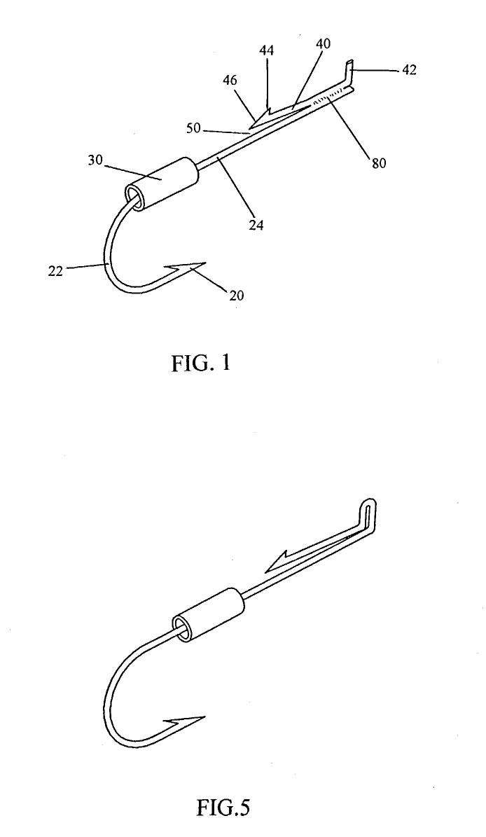

Referring to FIG. 1, there is shown a shank 24 of a fishhook with a bend 22, which ends in a barb 20. Around the shank 24 is a locking tube 30. Attached to said shank 24 at the opposite and opposed end from said barb 20 is a line gripping appendage called a locking arm 40. Said locking arm 40 is comprised of an elongated body with a top nub 42 and a locking arm tip 46 at one end, and a bottom nub 44 at the other. The locking arm 40 is attached to the shank 24 by means of a join 80 so that the locking arm tip 46 points to bend 22. FIG. 1 further shows that the locking arm 40 is attached in such a manner as to provide an open ended angle 50 beginning at its locking arm tip 46. Said open ended angle 50 narrows and extends back towards the top nub 42, where it meets the shank 24 at join 80. The open ended angle 50 is of sufficient width and length that it easily accommodates fishing line 70 as shown in FIG. 3. Also FIG. 1 shows the locking tube 30 is of sufficient inside diameter to accommodate shank 24 and the bottom nub 44 when it is compressed down into the shank 24. The height of the bottom nub 44 is such, that it will allow the locking tube 30 to slide on or off the locking arm 40 when the locking arm 40 is compressed down into the shank 24. The locking arm tip 46 has enough area so that a fingertip can gain purchase on it, and is angled such that locking arm 30 can ride up it to pass over bottom nub 44. The height of the top nub 42 is high enough so that the locking tube 30, when engaged over the locking arm 40, cannot slide off.

The materials most likely used in construction in the locking arm 40 with its top nub 42, bottom nub 44 and locking arm tip 46 will be that of the shank 24, which is metal wire. However any suitable material can be used so long as it is flexible enough to be pressed down into the shank 24, and provide enough upward tension against the locking tube 30 when it is engaged over the locking arm 40. The locking tube 30 likewise can be made of metal, plastic or any other material deemed suitable to its task and then environment in which it is used.

### OPERATION OF INVENTION

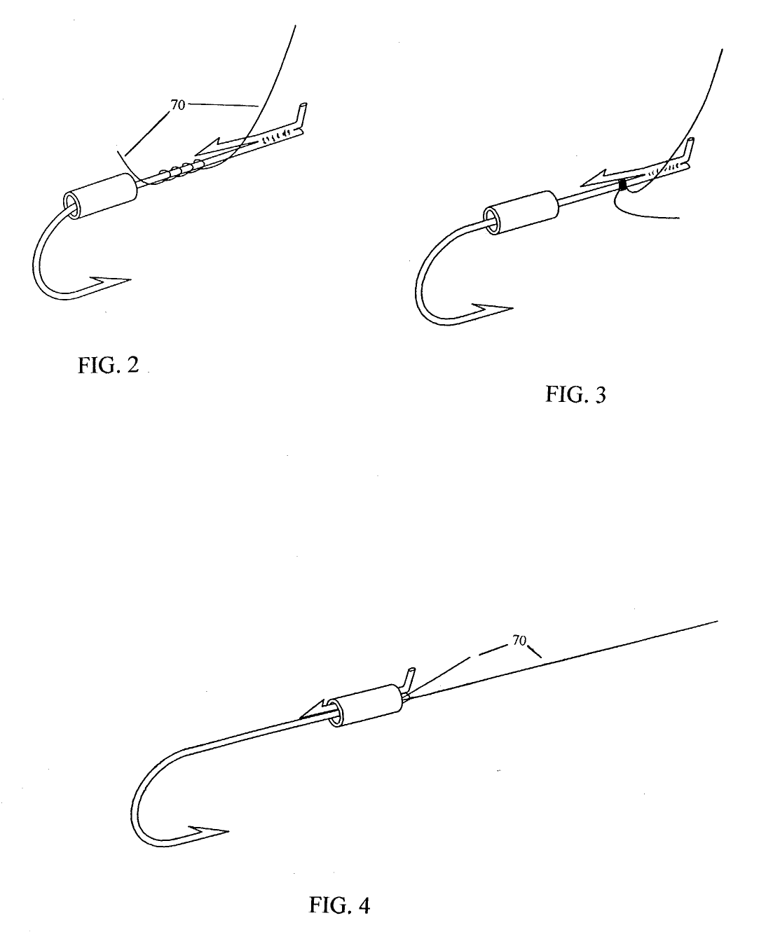

FIG. 2 shows the invention in the first stage of line attachment. The invention is held in front of the user with the barb 20 facing downward and the shank 24 horizontal to the user. The locking tube 30 is held with the users fingers in its rear position as far as it can travel against the bend 22. Still in FIG. 2, the end of the fishing line 70 is held along with the locking tube 30 and the line is wrapped snuggly a number of times around the shank 24. Then in FIG. 3, the wrapped line is pushed as far as it can go into the open ended angle 50 underneath the locking arm 40. Now the user presses the locking arm 40 down into the shank 24 and slides the locking tube 30 forward up locking arm tip 46 and over bottom nub 44 so that the inside of the locking tube 30 encapsulates the locking arm 40, the wrapped fishing line and the shank 24. The locking tube 30 is continually slid forward until it is between both the bottom nub 44 and the top nub 42. As the locking tube 30 reaches the top nub 42, the bottom nub 44 will come out from inside the locking tube 30 and spring up and away from the shank 24. This allows the bottom nub 44 to prevent the locking tube 30 from sliding back off the locking arm 40. The invention can now be baited and used to catch fish. The height of top nub 42 prevents the locking tube 30 from sliding off the invention. The locking tube 30, and locking arm 40 provide the positive locking means to secure the fishing line to the shank 24 by two means. First, the line is clamped between the shank 24 and the locking arm 40. Second, the locking tube 30 prevents the fishing line from being pulled in such a manner as to yank the wrapped line back out from underneath the locking arm 40. Furthermore the locking tube 30 keeps the line in linear conjunction with the shank 24 so the hook hangs on the line, as it would if it were an eyelet-based fishhook.

To disengage the fishing line the user simply presses down on the locking arm tip 46, until the locking tube 30 can be slid back over the bottom nub 44 and off the locking arm 40. Then the user pushes the wrapped line out from underneath the locking arm 40, and pulls it free.

### CONCLUSION, RAMIFICATIONS AND SCOPE OF INVENTION

Accordingly, the reader will see that the invention will allow the user to easily and rapidly attach and detach fishing line to it. This promotes increased enjoyment and the possibility of more success in fishing. In addition, when the user wants to switch to another size or tackle type, my invention has the advantage of being reusable. Further, the invention has the ability to accept most line sizes, this makes it cost and space efficient.

As mentioned previously, the unlimited range of colors, shades and patterns possible, gives the invention increased appeal by aiding in the attraction of fish. Additional attractants such as luminescent coatings, and fin, leg, or weed-less appendages give rise to additional possibilities in baiting fish. Different materials used to construct the invention give it the possibility to perform differently underwater, like being positively or negatively buoyant. Some materials or coatings may even incorporate scents or flavors.

While my above description contains many specificities, these should not be construed as limitations on the scope of the invention, but rather as an exemplification of one preferred embodiment thereof Many other variations are possible. For example the principle behind the locking arm and locking tube can be applied to most any form of terminal tackle or device where the user needs to attach a line to an object. Different construction methods are possible, one example is shown in FIG. 5. This example shows an elongated shank wire formed to construct the locking arm, nubs, and tip. Another method could employ injection molding to form the locking arm and nubs. Any construction method deemed suitable can be used.

I claim:

1. An article of terminal tackle comprising:
(a) a shank portion
(b) a line gripping appendage attached to said shank portion
(c) a tubular body encapsulated around said shank portion

2. The article of terminal tackle in claim 1 wherein said line gripping appendage has a nub at each of its opposed ends, said line gripping appendage provides a means for holding line to said shank portion.

3. The article of terminal tackle in claim 2 wherein said tubular body can encapsulate said shank portion and said line gripping appendage, providing a means of continual pressure on the line between said shank portion and said line gripping appendage.

4. The article of terminal tackle in claim 2 wherein said nubs on said line gripping appendage provide a means to hold said tubular body in place while encapsulating said shank portion and said line gripping appendage.

5. A method of attaching line to an article of terminal tackle defined as a shank portion, a line gripping appendage, said line gripping appendage has a nub at each of its ends and a tubular body, comprising the steps of:
(a) wrapping the line multiple times around said shank portion
(b) pushing wrapped line underneath said line gripping appendage
(c) pushing said line gripping appendage to said shank portion
(d) sliding said tubular body to encapsulate both said line gripping appendage and said shank portion
